(19) United States
(12) Patent Application Publication
(10) Pub. No.: US 2005/0197867 A1
(43) Pub. Date: Sep. 8, 2005

(54) Method and system for managing transactions in a remote network access system

(76) Inventors: Jeff Steven Edgett, Sunnyvale, CA (US); Michelle Lynn Brahm, San Francisco, CA (US); Dmitriy A. Solovey, San Jose, CA (US); Julie Holding, Palo Alto, CA (US); Raghu Konka, Sunnyvale, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/843,790

(22) Filed: May 11, 2004

Related U.S. Application Data
(63) Continuation of application No. PCT/US04/04971, filed on Feb. 18, 2004.

(51) Int. Cl. G06F 11/00; G08C 15/00

(52) U.S. Cl. 705/5

(57) ABSTRACT

A system and method is provided to manage access transactions associated with a plurality of parties in a multi-party service access environment. The method may be executed at a transaction broker and comprise providing a plurality of pricing plans, each party being associated with at least one of the plurality of pricing plans; and providing a plurality of pricing relationships associated with each pricing plan, each pricing relationship defining a payer/payee relationships between at least two parties to the multi-party service access environment. The method may comprise generating a graphic user interface that allows functionality selected from the group including adding a pricing plan, editing a pricing plan, copying a pricing plan, and removing a pricing plan. In one embodiment, the method comprises associating at least one pricing map with each pricing group, the at least one pricing group may include a plurality of network access points that have substantially similar pricing characteristics.

### CLAIM OF PRIORITY

This application is a continuation of and claims the priority of International Application No. PCT/US04/04971 filed on Feb. 28, 2004, the content of which is incorporated herein by reference.

### FIELD OF THE INVENTION

The present invention relates generally to transactions arising from remote network connectivity. More particularly, the present invention relates to a network transaction manager and to a method to manage network transactions.

### BACKGROUND

Due to the increasing globalization of economies, the need to provide communications between geographically dispersed persons and facilities has increased. For example, a particular business may have facilities located across multiple countries and continents. A further result of increased globalization has been an increase in business travel. The increasing dependence of corporations and persons on Internet-based communications has furthermore made it desirable that mobile workers (so-called “road warriors”) be able to access Internet-based and wireless communications as they travel worldwide. Services that facilitate communications to such mobile persons are commonly referred to as “roaming services”. Considering Internet-based communications as an example, in order to meet the needs of mobile customers, Internet Service Providers (ISPS) have begun to offer local-call access to the Internet from various locations world wide, such a service being termed a “roaming” Internet access solution.

The requirement for a roaming solution arises primarily because ISPs tend to specialize by geographic area, causing gaps in service coverage. The expansion of network infrastructure, network management and continuous upgrades to meet required reliability and performance standards all place tremendous capital and time burdens on ISPs. Accordingly, many ISPs only provide Points of Presence (POPs) in a limited geographic area.

In order to gain additional geographic reach, network aggregators or brokers aggregate network services provided by a multitude of network suppliers. In these circumstances, the network broker may charge a user for the roaming service and pay the network supplier for use of their network. It will be appreciated that, as the number of relationships between network suppliers (e.g., ISPs) increase in an attempt to provide global coverage, managing and processing transactional information and sharing costs may become complex.

### SUMMARY OF THE INVENTION

In accordance with the invention, there is provided a method to manage access transactions associated with a plurality of parties in a multi-party service access environment, the method comprising:
providing a plurality of pricing plans, each party being associated with at least one of the plurality of pricing plans; and
providing a plurality of pricing relationships associated with each pricing plan, each pricing relationship defining a payer/payee relationship between at least two parties to the multi-party service access environment.

The method may comprise providing a plurality of pricing groups; and associating each pricing group with a pricing plan.

In one embodiment, the method comprises generating a graphic user interface that allows functionality selected from the group including adding a pricing plan, editing a pricing plan, copying a pricing plan, and removing a pricing plan. The method may comprise associating at least one pricing map with each pricing group, the at least one pricing group including a plurality of network access points that have substantially similar pricing characteristics. In one embodiment, the method generates a graphic user interface that allows a user to define the pricing characteristics associated with the pricing group. The at least one pricing map may comprise a plurality of access points having common access criteria.

In one embodiment, the method generates a graphic user interface that allows user selection of access criteria common to the pricing map, the common access criteria being selected from the group including a geographical region, a country, a state, a network access type, a media access type, and a site type.

The relationships between the plurality of parties to the multi-party service access environment may be payer/payee relationships. The method may generate a graphic user interface which allows a user to define a payer and a payee in each payer/payee relationship. Multiple payer/payee relationships may be associated with a single access transaction. The transaction may be measured in one of units of time, a fee per transaction, units of data volume, access speed, or the like. A first payer/payee relationship may regulate financial charges between the customer and an access broker, and a second payer/payee relationship may regulate financial charges between the access broker and a network service provider.

The method may comprise defining rate criteria associated with each payer/payee relationship, the rate criteria including a financial charge which is based on at least one of a device type, a time unit, and a geographical location. Each access transaction may have at least two different associated rate criteria.

In certain embodiments, the method comprises defining a rate associated with each access transaction and monitoring customer access and adjusting the rate when the customer access reaches a threshold value. The threshold value may be at least one of a maximum pricing parameter and a minimum pricing parameter. The maximum pricing parameter may define a maximum charge for access during a given time period and/or a given data volume period, and the minimum pricing parameter may define a minimum charge for access during the given time period and/or the given data volume period. The method may comprise generating a graphic user interface which allows setting of the rate threshold.

The method may comprise providing the customer network access in the multi-party service access environment via a network broker that aggregates a plurality of network service providers, the network broker managing transactions between the network broker and the customer, and transactions between the network broker and the plurality of network service providers, the transactions arising from access by a party to a network of any one of the network service providers. A first payer/payee relationship may regulate financial charges between the customer and a network service provider, and a second payer/payee relationship may regulate financial charges between the customer and the access broker. In addition or instead, a first payer/payee relationship may regulate financial charges between the customer and a reseller, the second payer/payee relationship may regulate financial charges between the reseller and the access broker, and a third payer/payee relationship may regulate financial charges between the access broker and the network service provider.

Still further in accordance with the invention, there is provided a transaction management module to manage access transactions by a plurality of parties in a multi-party service access environment, the transaction module comprising:
a pricing plan module defining a plurality of pricing plans, each party being associated with at least one pricing plan; and
a plurality of payment relationship modules associated with each pricing plan and wherein each pricing relationship module defines pricing relationships between at least two parties to the multi-party service access environment.

The transaction management module may comprise a plurality of pricing group modules that are associated with a pricing plan. Each pricing group may comprise at least one pricing map module that defines a pricing map including a plurality of network access points that have substantially similar pricing characteristics. The at least one pricing map module may comprise a plurality of access points having common access criteria.

The common access criteria may include one of a common media type, a common network service provider, a common geographic location, and a common media site type. The common media type may comprise one of a dialup network, a Wi-Fi network, a cable network, and a DSL network. The common media site type may relate to physical business locations performing substantially similar business functions.

The transaction management module may comprise a payer/payee module wherein the relationships between the plurality of parties to the multi-party service access environment are payer/payee relationships are defined. Multiple payer/payee relationships may be associated with a single access transaction. A first payer/payee relationship may regulate financial charges between the access customer and an access broker, and a second payer/payee relationship may regulate financial charges between the access broker and an network service provider.

The transaction payer/payee module may define multiple payer/payee relationships wherein a combination of the multiple payer/payee relationships may relate to a single pricing plan.

The transaction management module may comprise a rates module to define a rate associated with each access transaction and wherein the rates module monitors access by a party and adjusts the rate when customer access reaches a threshold value.

The transaction management module may comprise a rate counter for monitoring when access by a party reaches the threshold value.

The invention extends to a machine-readable medium embodying a sequence of instructions for carrying out any of the methods described herein.

Other features and advantages of the present invention will be apparent from the drawings and detailed description that follow.

### BRIEF DESCRIPTION OF THE DRAWINGS

The invention is illustrated by way of example, and not limitation, with reference to the accompanying diagrammatic drawings, in which like references numerals indicate the same or similar elements.

In the drawings,

FIG. 1 is a schematic block diagram of a multi-party service access environment, in accordance with an exemplary embodiment of the invention, which includes multiple service providers, an access broker system, and multiple customers;

FIG. 2 is a schematic diagram illustrating operation of an access broker system, in accordance with an exemplary embodiment of the invention, that provides roaming Internet access;

FIG. 3 is a schematic functional block diagram of an exemplary transaction management module, in accordance with the invention, to manage transactions between customers and network service providers in an exemplary multi-party service access environment;

FIG. 4 is a schematic diagram of an exemplary pricing plan module including a plurality of exemplary pricing group modules, in accordance with the invention;

FIG. 5 is a schematic diagram of an exemplary pricing map module, in accordance with the invention;

FIG. 6 is a schematic diagram of an exemplary rates module, in accordance with the invention;

FIG. 7 is a schematic diagram of a plurality of exemplary pricing relationships (e.g., payer/payee relationships) in a pricing relationship module, in accordance with the invention;

FIG. 8 is a schematic diagram of an exemplary rate counter module, in accordance with the invention;

FIGS. 9-15 show exemplary graphic user interfaces generated by the transaction management module;

FIG. 16 shows an exemplary database schema of the transaction management module;

FIG. 17 shows a schematic representation of an exemplary method, in accordance with the invention, to manage access transactions associated with a plurality of customers in a multi-party service access environment; and

FIG. 18 is a schematic block diagram of an exemplary machine for executing any one or more of the methods or modules described herein.

### DETAILED DESCRIPTION

A method and system to manage transaction data are described. A typical application of the invention is in a multi-party service access environment and its application therein is described below by way of example. Such applications typically include roaming users, multiple service providers, and multiple customers. For example, in such an environment, a roaming user located in a geographical location remote from his/her “home” service provider can establish a network connection to a local service provider (e.g., to obtain Internet access). Accordingly, a long distance call by the user from the remote geographical location to the “home” service provider may be avoided which may have significant cost advantages. Further, certain network services (e.g., DSL lines) may not be available via such a long distance call and making a local connection to a local service provider may provide numerous advantages (e.g., enhanced bandwidth). Further, various different local services and content may be provided by the local service provider.

For the purposes of the present specification, the term “service access transaction” includes any transaction between a service customer and a-network service provider for a user session. An example of such a service may be access to any communications network via any medium or protocol. For example, the communications networks may comprise packet-switched networks, circuit-switched networks, cable networks, satellite networks, terrestrial networks, wired networks, or wireless networks. The term “service access transaction”, however, is not limited to a network access transaction, and may encompass a transaction pertaining to access to any one of a number of other services such as content, commerce and communications services.

For the purposes of the present specification, the term “customer” includes any entity involved in the purchase and/or consumption of service access, regardless of whether the service access is performed by the customer or not. For example, a “customer” may be an end-user consumer that actually utilizes the service access, or a corporate entity to which such an end-user belongs, an Internet service provider, an Internet carrier, a reseller, a channel, or the like.

The exemplary embodiment of the present invention discloses a transaction management system and method to manage service access (e.g., Internet access, content access, commerce access, or communications access) services via a plurality of service providers (e.g., an ISP, a wireless service provider, a VPN service provider, a content distribution service provider, an e-commerce service provider or an application service provider).

Multi-Party Service Access Environment

Referring to the drawings, reference numeral 20 generally indicates an exemplary multi-party service access environment, in the exemplary form of a network access environment. The network access environment 20 includes a plurality of service access providers 22, an access broker system 24, in accordance with the invention, and multiple customers (or consumers) 26. At a high level, the service access providers 22 have service (e.g., access, content, e-commerce services etc.) capacity that is sold, via the access broker system 24, to the multiple customers 26. Accordingly, the access broker system 24 may be regarded as aggregating or purchasing service capacity (e.g., service access), which is then resold to the customers 26. In the exemplary embodiment, the service access providers 22 may include any communication network service providers, such as ISPs 28 (e.g., UUNet Technologies, Genuity, CompuServe Network Services, EQUANT, Hong Kong Telecom, etc.), wireless access providers 30 (e.g., Verizon, Sprint, Pacific Bell, etc), content distribution providers 32 and e-commerce providers 34. It will however be appreciated that the service access providers 22 may, however, include any number or type of service providers providing any number of services (e.g., access, content, communications or e-commerce services, to name but a few).

The exemplary access broker system 24 is shown to include a number of exemplary functional modules that may be located at different physical locations. It will be appreciated that various embodiments of the inventions may not include all the modules shown by way of example or may include other modules.

The access broker system 24 may include a connection application (a client application) in the form of a dial-up application or connect dialer 36, installed on a service or network access device (e.g., a computer system) of a customer 26 that facilitates convenient access to a communications network of any one of the service access providers 22. In one embodiment, the connect dialer 36 may provide a simple point-and-click interface for dialing into a worldwide connection network of the access broker system 24. To this end, the connect dialer 36 may store multiple phone numbers for multiple ISPs (network service access providers 22) worldwide with potentially different setup and dial-up scripting information.

The access broker system 24 may also include a plurality of transaction servers 38, roam servers 40, netservers 42, a settlement system 44, a service quality monitor system 46, and a phonebook management system 48. The transaction servers 38 may provide trusted third-party functionality of routing and logging user identification information, authorization responses and usage, and accounting information.

Whereas the connect dialer 36 may be installed on a client or user network access device, the netservers 42 may be installed at a “remote” ISP allowing its POPs to be utilized by roaming users, and roam servers 40 reside at a “home” ISP to allow a roam user access an associated home network. It should be noted that the transaction servers 28 might operate to route messages between the network servers 42 and the roam servers 40.

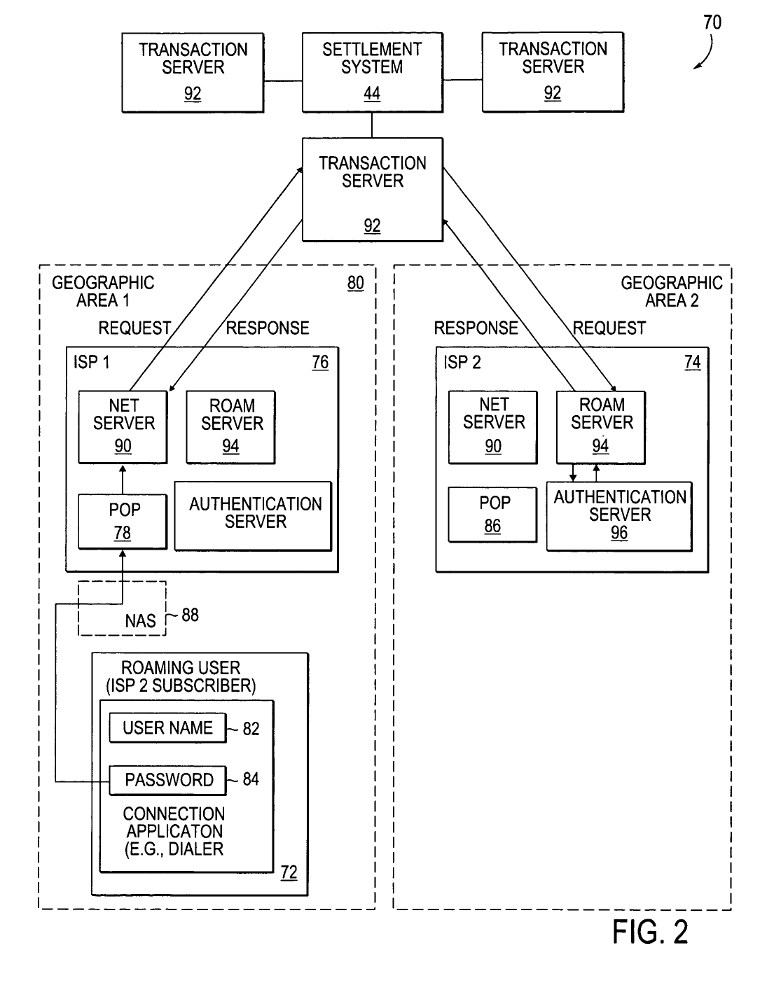

The settlement system 44, including a transaction management module 50, performs financial settlement of service access transactions between the service access providers 22 and the customers 26. The Service Quality Monitor (SQM) system 46 may facilitate the collection and analysis of quality of service (QoS) information for services provided to customers 26 and a Phonebook Management System 48 may facilitate management of multiple connect dialers 36 used by customers 26. The transaction servers 38 may be accessed by the settlement system 44 to load transaction data (see FIG. 2). The various components in the multi-party service access environment 20 may include aspects of known functionality and, dependent upon the specific embodiment of the invention, certain components may be omitted and other components may be added.

The Customers

The customers 26, in the embodiment depicted in the drawings, are arranged in an exemplary multi-tier customer structure, whereby the access broker system 24 may interact with customers 26 that operate according to a variety of business plans and needs. At one end of the spectrum, the customer 26 may comprise an individual end-user that subscribes to roaming network access facilitated via the access broker system 24. Alternatively, the customer 26 may be in the form of a corporate customer 52 (e.g., a corporation or business) that purchases roaming network (e.g. Internet) access for employees of the corporation.

Each customer 26 may also comprise an ISP customer 54 that purchases roaming Internet access for resale to its customers (e.g., end-users 56 and corporate customers 52). Each customer 26 may also operate as a solution partner or reseller 58 that markets and resells roaming Internet access brokered by the access broker system 24 to end-users 56, corporate customers 52 and/or ISP customers 54.

The customers 26 may also include parties regarded as Internet Carriers 60 (e.g., IXCs, RBOs, CLECs, ILECs and ISPs). It will thus be appreciated that in the multi-party access environment 20 a number of different service providers may participate in providing access to a roaming user and, accordingly, managing the transactions (e.g., pricing structures) may be of importance. Also, as the number of customers 26 and service access providers 22 increase, accounting issues tend to become more complex. For example, the price that a customer 26 pays for network access via a service access provider may vary widely based on criteria such as location, media or connection type (dial, DSL, Wi-Fi, etc), data volume and the like.

Roaming Service Access

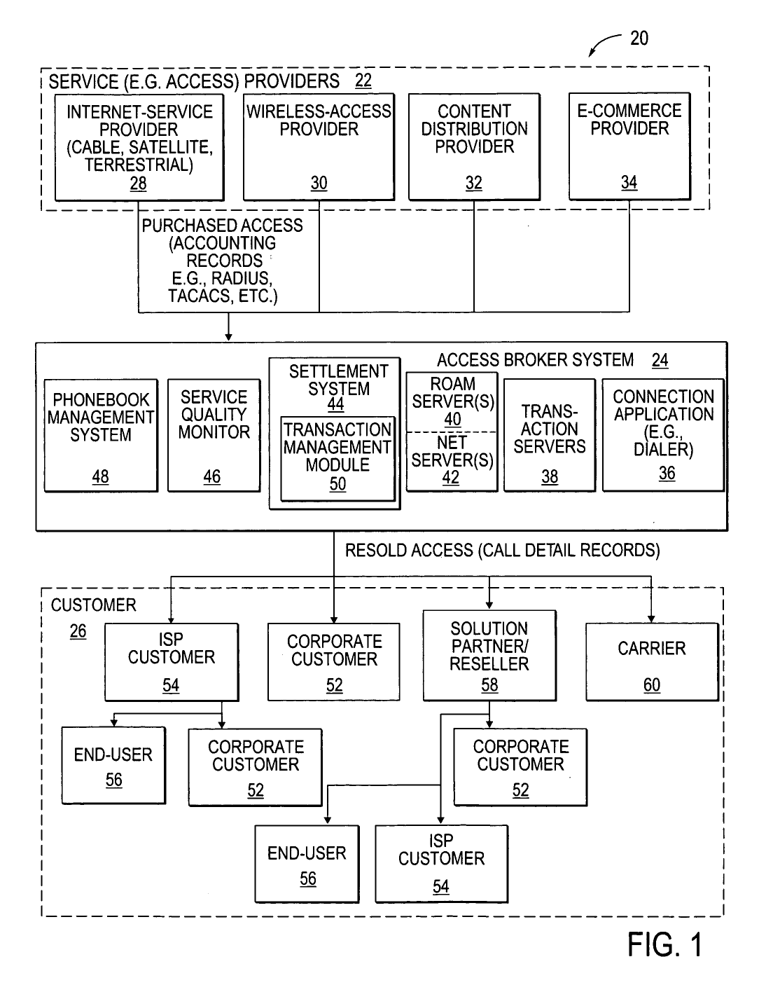

Referring in particular to FIG. 2, reference numeral 70 generally indicates exemplary operation of the access broker system 24 in providing roaming Internet access in a relatively secure manner to a plurality of customer via any one of the plurality of service access providers 22. When a roaming user 72, shown to be a subscriber to a “home” ISP 74, connects to a remote ISP 76 that provides a local POP 78 within a specific geographic area 80, the roaming user 72 may input the same user name 82 and password 84 (authentication data or user credentials) used when connecting via a POP 86 of the “home” ISP 74. In the exemplary embodiment depicted in FIG. 2, the roaming user 72 may connect to the POP 78 via a network access server (NAS) 88. A netserver 90 of the ISP 76 may them establish a connection with a transaction server 92 (see also the transaction servers 38 in FIG. 1). The transaction server 92 may then communicate with a roam server 94 of the “home” ISP 74. The “home” ISP 74 may then authenticate the roaming user 72 via an authentication server 96 and communicate its authentication response to the transaction server 92. The transaction server 92 may then communicate with the netserver 90 thereby to permit or deny access to the roaming user 72. In one exemplary embodiment, the roaming user 72 may for example be authenticated using PAP for dialup authentication and HTTP POST based authentication for wired and wireless broadband authentication. It will however be appreciated that any authentication protocol may be used.

In order to facilitate explanation of roaming service access, FIG. 2 shows only two service access providers 22 namely, the exemplary ISPs 74 and 76. However, it will be appreciated that the access broker system 24 may aggregate or have arrangements with a multitude of different service access providers 22 to facilitate global connectivity for the roaming user 72 (or multitude of customers 26 in FIG. 1). Further, the price that a network or service access provider is paid may also vary from one provider to another. The transaction management module 50 and the method it implements, both in accordance with the invention, allows the network access broker system 24 to manage transaction data in a multi-party roaming service access environment.

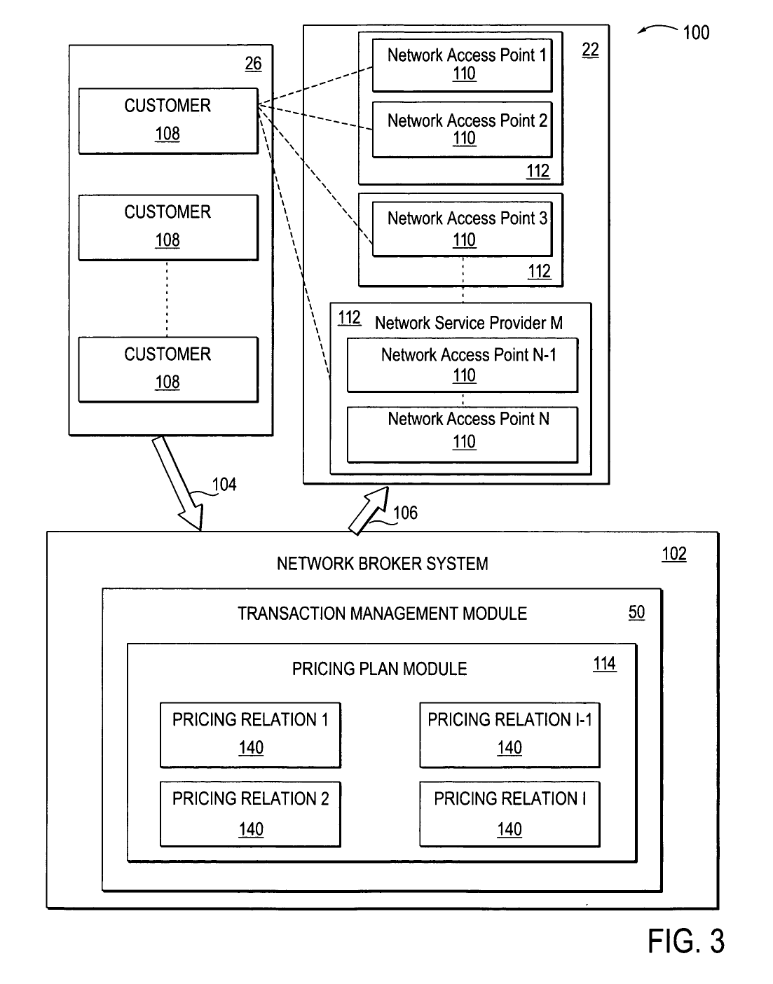

Referring in particular to FIG. 3, reference numeral 100 generally indicates a further embodiment of a multi-party service access environment including a network broker system 102. The network broker system 102 may resemble the access broker system 24 and include any one or more of the components shown in FIG. 1. As in the case of the network broker system 24, the network broker system 102 includes a transaction management module 50 for managing multiple transactions such as consumer transactions as shown by arrow 104, and network service provider transactions as shown by arrow 106. As described in more detail below, the transaction management module 50 may support a wide multitude of pricing rates between various participants in the multi-party service access environment 100. By way of example, the customers 26 are shown to include a plurality of individual customers 108 each of which may obtain global network connectivity via any one of a plurality of network access points 110. It will be appreciated that any one or more of the network access points 110 may form part of a particular network access or service provider 112 and that any one of the customers 108 may obtain network connectivity via any one of the network service providers 112.

The network access points 110 are typically located at various different geographical points or locations across the globe and, in order to insure that a customer 108 may obtain network connectivity when proximate to any one of the network access points 110, the network broker system 102 may enter into agreements with the various network service providers 112 to allow the customers 108 of the network broker system 102 to access any one of the network service providers 112. Accordingly, the network broker system 102 may enter into agreements with various different network service providers 112 across the globe and, each of these network service providers 112 may have particular transaction requirements, e.g., pricing requirements or the like. Likewise, each customer 108 may have various pricing criteria associated therewith. Thus, in one embodiment, in order to manage transaction data associated with a service access transaction (e.g., use of a network of any one of the network service providers 112 by any one of the customers 108), the transaction management module 50 may include one or more pricing plan modules 114 to define pricing relationships (e.g., payer/payee relationships) for service access transactions between a plurality of parties (e.g., the service provides 22 and the customers 26). Accordingly, by way of example, the pricing plan module 114 may take a plurality of payers and payees into account as well as a plurality of different rates that may apply for each service access transaction.

As shown in FIG. 3, the network service providers 112 may, for example, own the network access points 110 by which any one of the customers 108 gains access to the computer network. The network access points 110 may be located at different geographical locations and be made available to the customers 108 via the network broker system 102. As the network broker system 102 may have agreements with a plurality of different network service providers 112, it can provide the customers 108 with roaming network service access. The network broker system 112 may be responsible for payment (see arrow 106) of the network service providers 112 for the use of their network by any one of the customers. Likewise, the network broker system 102 may receive payment from the customers 108 (see arrow 104) for the roaming network access facility. In one embodiment, the network broker system 102 may define a plurality of pricing plans for different parties (including the customers 108 and the network service providers 112) of the multi-party service access environment 100 and, as more than one network service provider 112 may be involved in providing roaming access facilities to each customer 108, a plurality of pricing relationships in the exemplary form of payer/payee relationships may arise. The transaction management module 50 may then manage and define these transactions as described in more detail below.

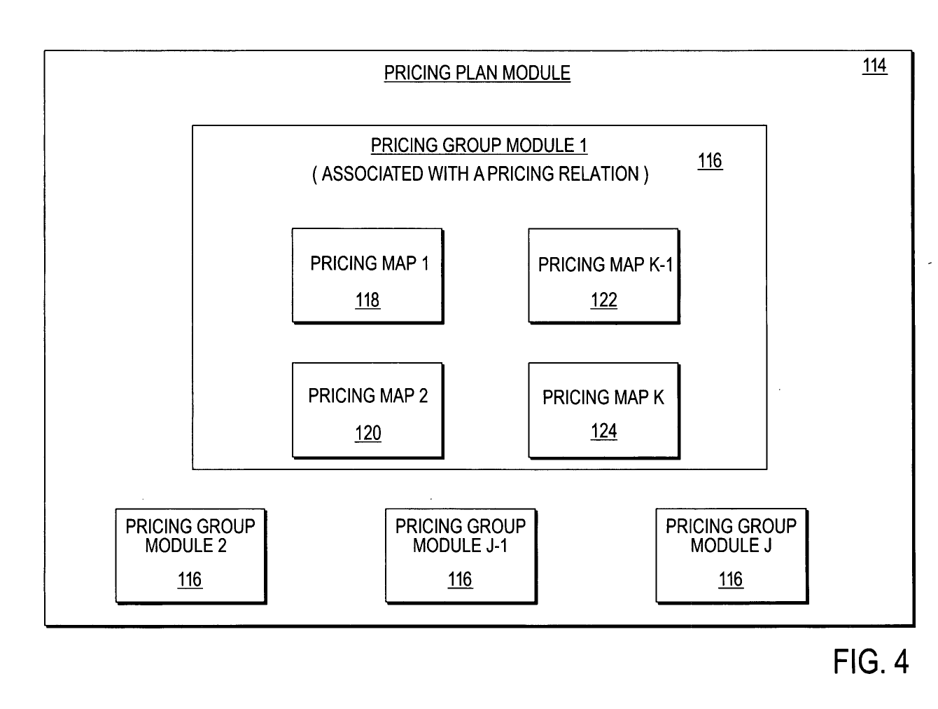

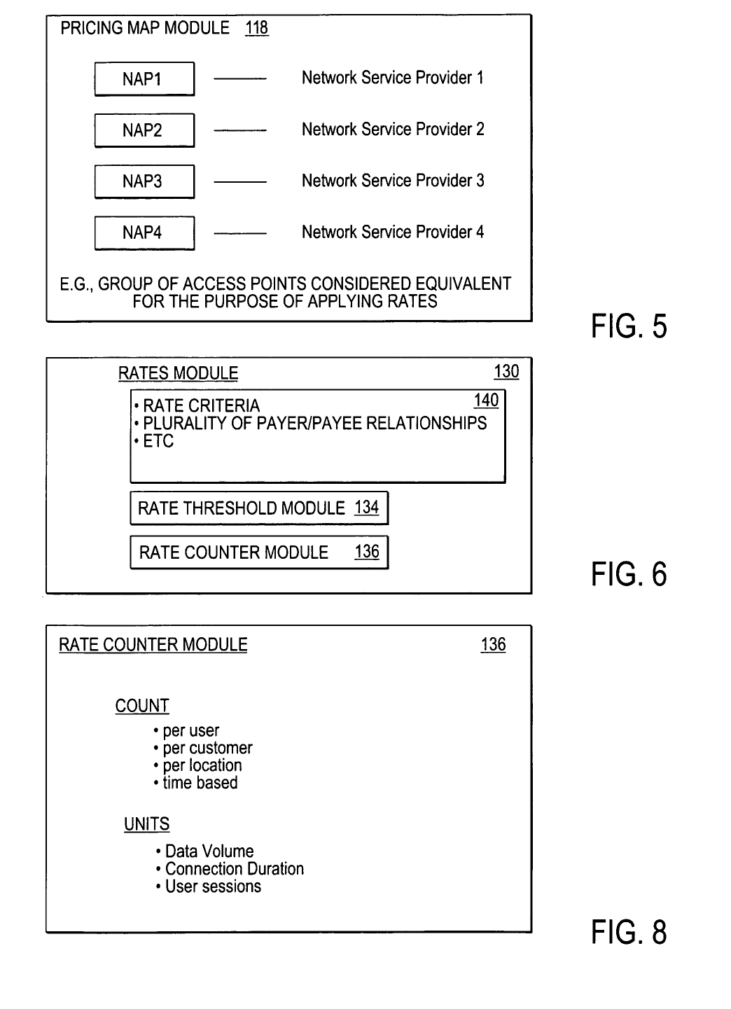

In one embodiment of the invention, the pricing plan module 114 includes a plurality of pricing group modules 116 (see FIG. 4) that, for example, each represent a set of locations (e.g., network access points 110) that may be considered equivalent for the purposes of applying financial or payment rates. As shown in FIG. 4, each pricing group module 116 may include a plurality of different pricing maps 118 to 124 wherein each pricing map 118 to 124 has similar or the same transaction charges or rates. In one exemplary embodiment, pricing maps 118 to 124 rated with similar pricing criteria are associated with the same pricing group module 116. A pricing relation may define a type of service being provided (e.g., network access, clearing or the like) and the parties involved in the in the transaction (e.g., customer 26, access broker system 24, service provider 22, or any other party).

In one embodiment, the network access points 110 included in any one of the exemplary pricing maps 118 to 124 may, for example, be based on the media or connection type (e.g., physical network type such as DSL, dialup, Wi-Fi etc.), the particular network service provider 112 that provides the network access point 110, the geographical location of the network access point 110 (e.g., country, state, city, or the like), the site type (e.g., a hotel, an airport, a restaurant, a coffee shop, or the like) and so on. Further, the network access points 110 that are included in a particular pricing map 118 to 124 need not necessarily be provided by the same network service provider 112. Accordingly, any number and combination of network access points 110 from any one or more of the network service providers 112 may be included in a particular pricing map 118 to 124. Further, it will be appreciated that each pricing group module 116 may, dependent upon the circumstances, include a single or any number of pricing maps (four of which are shown in FIG. 4 by way of example). In certain embodiments two or more pricing maps 118 to 124 may be applicable when a customer 26 requests access to the network. For example, assume that a particular pricing plan has two pricing maps, for example, a pricing map including North American locations and a pricing map including all broadband locations. If a user or customer 26 is using a broadband location in the USA, it may be ambiguous as to which pricing map should be selected to charge for usage and, accordingly, what price should be paid. Accordingly, in one embodiment, a weight may be assigned to each access criteria and, when more than one pricing map is applicable, a pricing map with a higher weight may be selected. Following on the example given above, if a weight given to geographic location is higher than media access type, the North American locations pricing map would be selected.

The transaction management module 50 may also include a rates module 130 that may define rate criteria, the plurality of payment (e.g., payer/payee) relationships, and/or the like. As mentioned above, each pricing plan may define a set of payment relationships between the various parties in the multi-party service access environment. Further, the rates module 130 may have associated rate threshold and rate counter modules 134 and 136, respectively. A rate threshold may be a point at which a rate may change. For example, when a user session is charged on an hourly basis, an hourly rate may for example be $2 for the first five hours of network access and, thereafter, $1.50 for each subsequent hour of network access. A rate counter of the rate counter module 136 may monitor user sessions and count any metered activity for which thresholds are being applied. The rate counters may count network access or usage per user, per customer, per location (e.g., for all locations), or the like (see FIG. 8). In one embodiment, the rate counter module 136 may count rates across multiple users (e.g., if the cumulative usage of all users in any given enterprise exceeds X hours in a time period (e.g., month) the hourly rate for that enterprise (customer) may then be reduced. In addition or instead, the rate counter module 136 may count rates across multiple independent transactions (e.g., usage by a single user across a set of service providers). It will be appreciated that rate counters of the rate counter module 136 need not apply top a single user or transaction. The rate counters may also be bounded by time (e.g., activity within a month). Counters may also be used in various embodiments to count in different units, for example, data volume (e.g., a number of bytes sent and received), connection duration, user session data, or the like. In one embodiment, the pricing plan module 114 includes a plurality of pricing plans each of which may define exemplary payer/payee relationships for transactions that a particular customer 108 may participate in. In one embodiment, each customer 108 is associated with a single pricing plan.

Each pricing plan of the pricing plan module 114 may define transaction data such as fees or charges that arise from a user session in various different ways. For example, a pricing plan may include any one or more of fixed fees, usage fees, or service type fees.

For example, fixed fees in a pricing plan may include the following: a 24-hour fee; a fixed daily fee; a monthly fee; a per device fee; a location fee; and/or a per user fee. The 24-hour fee may be a rolling 24-hour fee that may be charged for all usage occurring within a 24-hour period beginning with a first successful authentication. Subsequent successful authentications by the same user or device may not be charged until the 24-hour period has expired. Fixed daily fees may be provided in venues where users are expected to stay for a well-defined period of time. A hotel may charge a single fixed daily fee for all usage from a check-in time to check-out time (e.g., from noon until noon). A monthly fee may be charged once a month and may allow unlimited access by a user during the course of the month. A device fee may be charged by a network access broker for each unique device that accesses a particular network. Location fees may be assessed as a separate service charge and may be done in conjunction with daily fees and user fees. A user fee may be assessed against a unique Network Access Identifier (NAI).

Usage fees may, for example, be per byte, per minute, per authentication, and/or the like. Byte service charges may be associated per byte of usage during a user session. Some plans may charge for data consumption in larger discreet amounts. Minute service charges may be assessed per minute of use of the network by the user. Authentication or broker fees may be assessed as a charge for successful authentication.

Service type fees may alter the value of usage of a fixed fee and need not necessarily be charged in isolation. For example, a per minute charge may increase as the available bandwidth is increased. Service types may include walled garden, web and e-mail access, VPN access, bandwidth used, quality of service (QOS) requirements, and/or the like. In a walled garden environment, free access may be provided a limited portion of a network called the “walled garden”. This type of network may provide information about service availability or general network services such as weather, news, or the like. However, web and e-mail access may be charged on a fixed or usage fee basis and access to other services such as FTP and VPN may be limited subject to additional fees or charges. Users may, in certain embodiments, incur additional fees for enhanced bandwidth or bandwidth guarantees. Likewise, users may be charged an additional fee for guaranteed quality of service and for specific services such as streaming video and voice over IP.

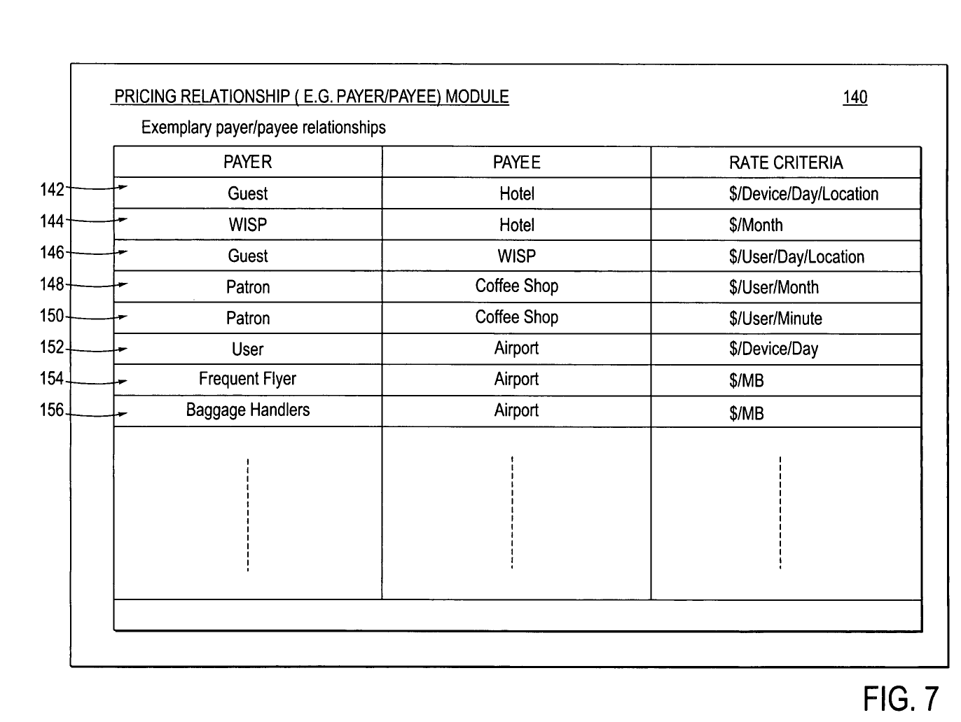

Referring to FIG. 7, reference numeral 140 shows a pricing relationship module in the exemplary form of a payer/payee module defining a plurality of exemplary payer/payee relationships. The payer/payee module 140 may form part of the rates module 130 (see FIG. 6) which may form part of a pricing plan module 114. It will be appreciated that any one or more of the modules shown in the drawings may be combined into one or more other modules and are shown as separate modules to aid explanation of their functionality. It will also be appreciated that the pricing relationship (e.g., payer/payee) module 140 may define relationships between a plurality of parties such as any one or more payees and any one or more payers.

For example, in a simple hotel scenario, the payer may be a guest and the payee may be a hotel. In these circumstances, the rate criteria may be defined by a dollar payment/device/day/location (see for example row 142). Thus, a hotel may require each guest to, for example, pre-pay a fixed daily fee for each device that requires network access. This may, for example, allow the guests to access the network provided in the hotel using their own laptop from noon on the day of check-in to noon on the day of check-out at the particular hotel at which they have registered. The payer may be a WISP (Wireless Internet Service Provider) and the payee may be the hotel (see row 144). The rate criteria may then be defined by dollar/month and apply, for example, when a hotel offers their venue to a local WISP and charges the WISP a monthly dollar fee. As mentioned above, in certain embodiments, the WISP may provide a walled garden providing, for example, information about the hotel as well as sports scores and financial information. The walled garden may be accessible at no charge to a user. However, the WISP may charge each user a dollar fee (e.g., per day) for access to the Internet. Thus, in these circumstances, from the point of view of the access broker system 24, the WISP may be a payer of a monthly fee and the hotel may be the payee of the monthly fee, whereas the guest may be the payer of the dollar/user/day/location fee and the WISP may be the payee. Rows 144 and rows 146 may respectively define these relationships. It will thus be appreciated that the payer/payee module 140 may manage a multiplicity of payer/payee relationships.

As shown at row 148, a further example of a payer/payee relationship may be a patron in a coffee shop. In these circumstances, the payer may be the patron and the payee may be the coffee shop and the rate criteria may be based on a dollar/user/month fee. However, the patron may not necessarily be a subscription customer and, accordingly, the patron may also pay for access by the minute in which case the rate criteria may be a dollar/user/minute fee (see row 150). Other examples also shown in the payer/payee relationship module 140 are a user at an airport (see row 152), a frequent flier at an airport (see row 154), and baggage handlers at an airport (see row 156). As shown in FIG. 7, the rate criteria may differ from one party or customer 108 to another.

It will thus be appreciated that the payer/payee relationship in the multi-party service access environment 100 may become relatively complex and the transaction management module 50 may facilitate the management thereof.

As described in more detail below, in one embodiment of the invention, the transaction management module 50 may define a pricing plan using the pricing plan module 114 wherein a plurality of pricing maps (e.g., pricing maps 118 to 124) are also defined. Each exemplary pricing map 118 to 124 may include a combination of location criteria as described above. For example, the pricing map 118 may include all North American Wi-Fi access points in airports. Further, for example, the pricing map 122 might include all dial-up access points in the United Kingdom and France that are supplied by a particular network service provider 112 (e.g., UUNET). Further, as described in more detail below, the access broker system 24 may also define a set of rate counters as well as a multitude of rates for a given pricing map 118 to 124 using one or more of the rate counter modules 136. Further, as mentioned above, in one embodiment, the rates module 130 may include a multitude of payer/payee relationships included, for example, in the exemplary payer/payee module 140 (see FIG. 7). The payer/payee relationships may vary for different participants in the roaming multi-party service access environment 100. In certain embodiments, the basis of payment between different participants may vary so that, for example, a customer may be charged by the access broker system 24 based on the volume of data sent/received by the user, whereas a network service provider 112 may be paid based on hours of access provided by the network access provider 112. In one embodiment, payment rates may vary based on set rate thresholds provided via the rate threshold module 134 in conjunction with the rate counters of the rate counter module 136. Thus, in one embodiment, one rate may apply for the first x minutes of connect time and thereafter a different rate may apply. In one embodiment minimum and/or maximum pricing parameters may be provided. For example, a minimum price parameter may define a price that a customer 26 is charged no matter how long the access session is (e.g., a fixed charge of $2 may be charged for usage up to 1 hour). In addition or instead, a maximum price parameter may define a maximum charge for any given time period irrespective of the amount of usage (e.g., the minimum rate may be $2 for use up to 1 hour, thereafter the hourly rate may be $1 per hour with a daily limit of $5).

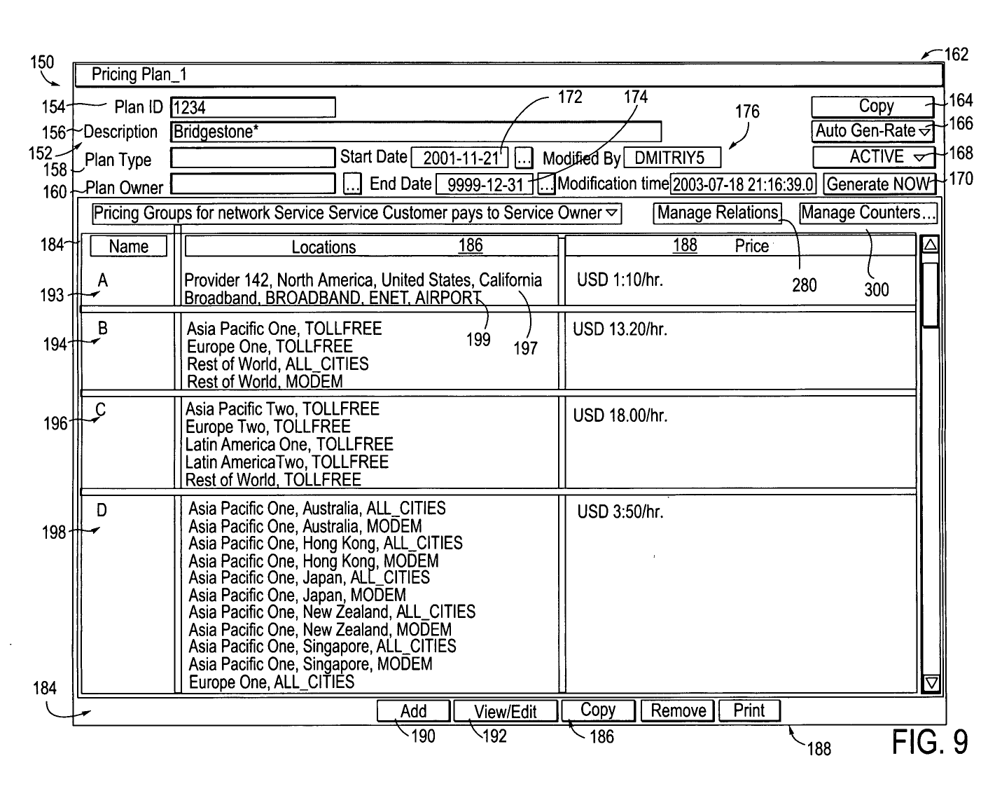

Referring to FIG. 9, reference numeral 150 generally indicates a graphic user interface defining an exemplary generic pricing plan main screen in accordance with the invention. An upper left portion 152 of the screen 150 shows pricing plan information including a Plan identifier or ID 154, a plan Description 156, a plan type 158, and a Plan Owner 160. An upper right portion 162 of the screen 150 includes control buttons including a Copy button 164, an Auto-Generate dropdown menu 166, an Active dropdown menu 168, and a Generate Now button 170. The buttons 164 to 170 may be used to copy an existing pricing plan (using the Copy button 164), to automatically generate a pricing plan (using the Auto-Generate Rate dropdown menu 166), to set an active flag using the Active dropdown menu 168, and initialize the generation of rate usage records using the Generate Now button 170. A start date 172 and an end date 174 as well as modification history data 176 may also be provided. It will be appreciated that different embodiments of the generate pricing plan main screen 150 may include any one or more, or other buttons, to perform required functionality.

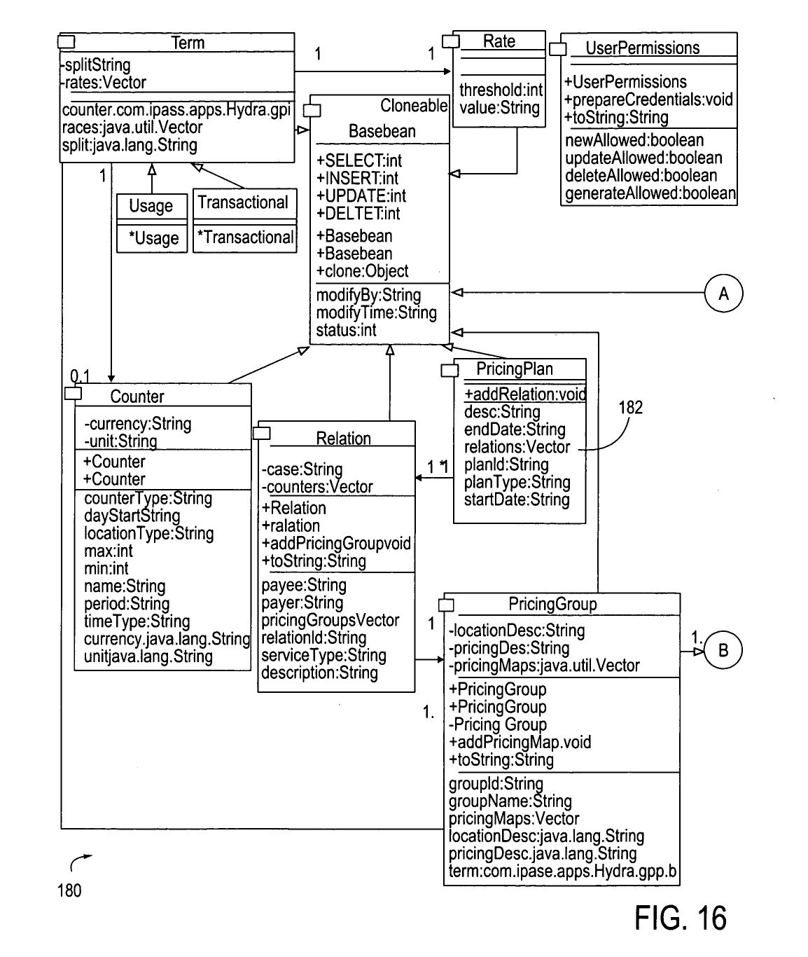

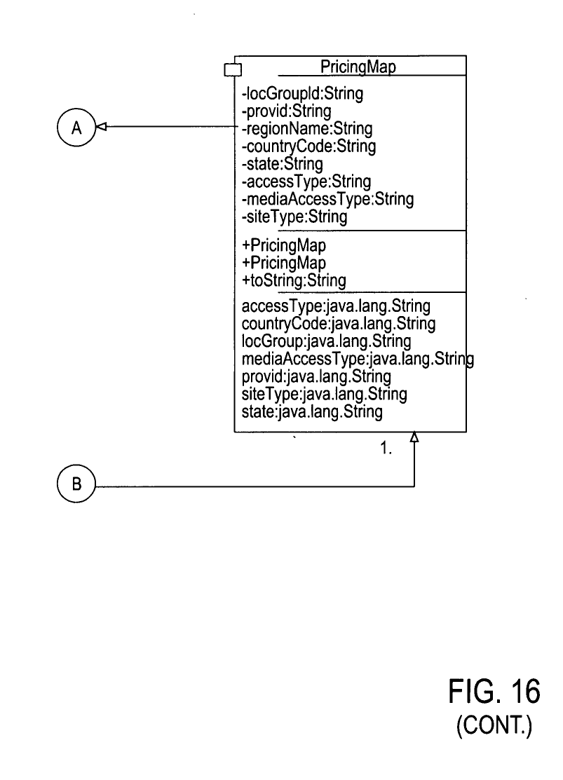

Using the screen 150, a user or administrator of the network broker system 102 (see FIG. 3) may thus generate a particular pricing plan (optionally using prior data). When defining a new pricing plan, the user provides a new Plan ID 154 and enters an appropriate Description 156 for the new pricing plan. Thereafter, a Plan Type 158 may be chosen and a Plan Owner 160 may then be entered followed by the Start date 172 and the End date 174 for the plan. In one embodiment of the invention, the Plan Type 158 may be selected from a list box that may provide valid values for a particular plan type (e.g., populate various fields in the screen 150 with appropriate default values). The pricing plan details may be stored in tables (see FIG. 16) of a data schema 180. For example, the pricing plan details may be stored in a PRICING_PLAN database table 182. In response to the data entered by the user, Name fields 184, Location fields 186, and Price rate fields 188 may then be populated. In certain embodiments, when the Auto-Generate Rate dropdown menu 166 is selected, and the rates are automatically generated, a list box may be provided with options to include or exclude suggested pricing groups.

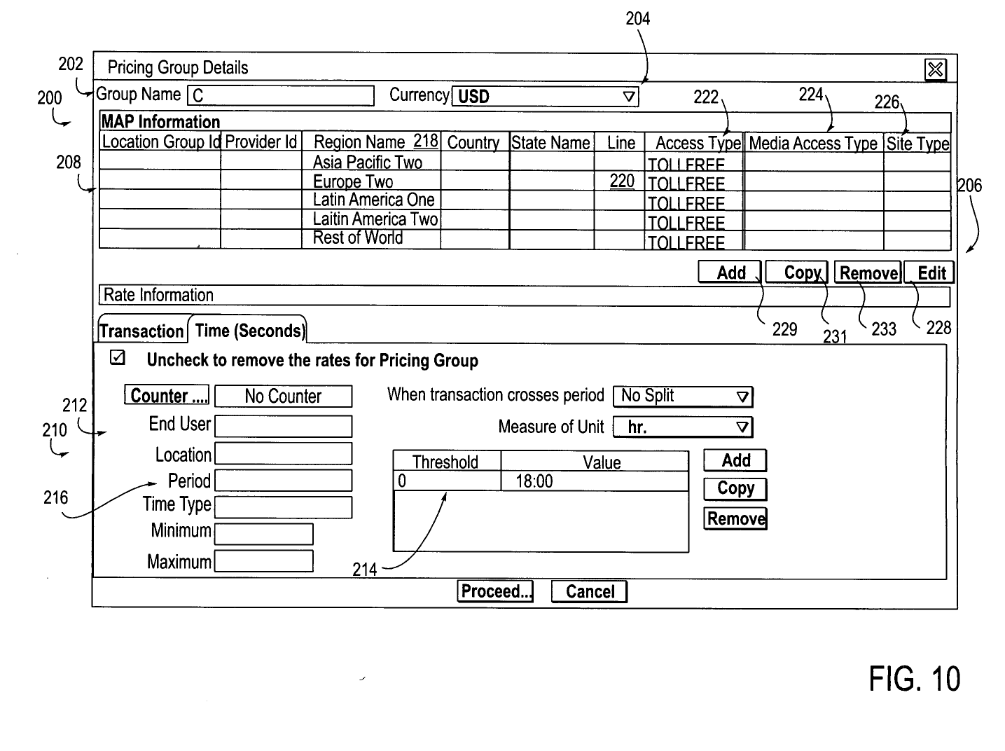

The Name fields 184 may identify various pricing groups 193, 194, 196, and 198 defined by the pricing plan module 114 (see FIG. 4). As mentioned above, each pricing group may include a plurality of pricing maps. By way of example, pricing group 193 is shown to include two pricing maps, namely pricing map 197 and pricing map 199. Likewise, pricing group 194 is shown by way of example to include four pricing maps that may correspond to the pricing maps 118 to 124 (see FIG. 4). Thus, each pricing plan may have one or more pricing groups which, in turn, may each have one or more pricing maps. In one embodiment, the user may define the exemplary pricing maps 193, 194, 196 and 198 using a graphic user interface in the form of a pricing group details screen 200 (see FIG. 10).

For example, if modifications are required to the pricing group 196, the user may highlight pricing group 196 on the screen 150 and click a View/Edit button 192 (see FIG. 9). The screen 200 may display the group name 202 (see FIG. 10) that has been selected and enable a user to select a currency using a dropdown menu 204. Further exemplary functionality is provided by Add, Copy, Remove and Edit buttons 206.

In a similar fashion to viewing and editing using the View/Edit button 192 (see FIG. 9), pricing groups may be added by activating an Add button 190 of the generic pricing plan main screen 150. In one embodiment of the invention, the pricing groups identified by the pricing group name field 184 may map one or more locations (see for example pricing maps 197 and 199) that fall under the same price. Thus, as mentioned above with reference to FIG. 3, all network access points 110 which have the same or substantially similar charges or rates may be grouped together in a common pricing map (e.g., the pricing maps 197 and 199). The pricing group details screen 200 may provide a pricing map details display area 208 wherein a plurality of different pricing maps (an information associated therewith) may be displayed that correspond to the particular pricing group name 202.

The pricing group details screen 200 also includes a rate information display area 210 that allows a user to enter rate information associated with the pricing group 202. The rate information display area 210 includes various check boxes and fields that are suitable for defining rate information in the multi-party service access environment 100. In one embodiment of the invention, the rate information display area 210 may be used to define rate thresholds and rate counters (see the rate threshold module 134 and the rate converter module 136 of FIG. 6). For example, the rate information display area 210 may include a counter field 212 and a rate threshold field 214 wherein a user may define counter values and rate threshold values. Various other fields such as an End User field, a Location field, a Period field, a Time Type field, a Minimum field, and a Maximum field, as generally indicated by reference numeral 216, may be provided. Returning to the pricing map details display area 208, a Region Name field 218 may be provided which is populated with values from a PRICING_REGION table (see FIG. 16). A Line field 220 may be provided in the form of a list box with values sourced from a LINE_TABLE. Further, an Access Type field 222 in the form of a list box may be provided with values sourced from an ACCESS_TYPE table. It will be appreciated that various other fields may be provided in the screen 200 such as, for example, a Media Access Type field 224 in the form of a list box with values from a MEDIA_ACCESS_TYPE table, a Site Type field 226 also in the form of a list box with values from a SITE_TYPE table. Thus, a user may define a pricing group as well as various different criteria or factors associated with the pricing group using the pricing group details screen 200.

Thus, in one embodiment, the pricing group details screen 200 allows a user to group various pricing maps into a pricing group and, using the rate information display area 210, the user may then apply a common payment rate to the pricing group. The user may also set an associated rate counter of the rate counter module 136 using the counter field 212 that, in one embodiment, provides a list of counters that may be defined for a selected currency and unit. For example, if a user selects a counter for a usage based rate, when the user clicks on the counter button 212 a list of counters that are defined for usage based applications is then provided to the user for selection.

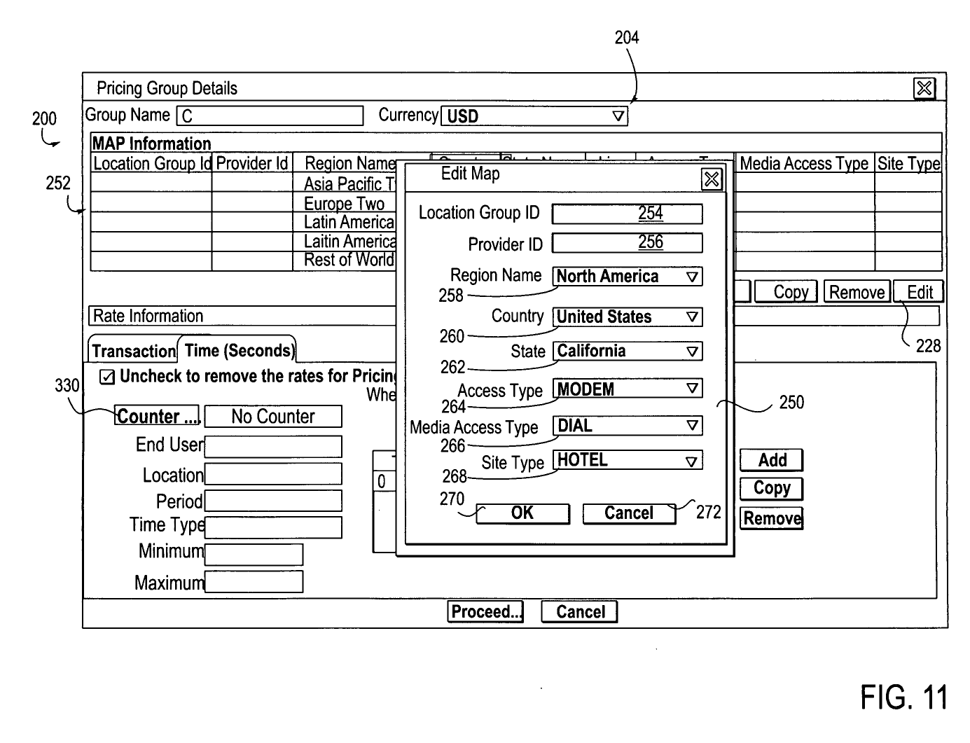

Returning to the buttons 206 (see FIG. 10), an Edit button 228 may be activated by a user in order to edit a particular pricing map displayed in the pricing map details display area 208. In particular, referring to FIG. 11, upon selection of a particular pricing map (e.g., pricing map 252) and thereafter activation of the Edit button 228, an edit map pop-up window 250 may be generated that allows the user to edit appropriate details of a selected pricing map (e.g., the pricing map 252 which has been highlighted by the user). The edit map pop-up window 250 includes a Location Group Identifier or ID field 254 that identifies a geographical location covered by the selected pricing map, a Provider Identification or ID field 256 that identifies, for example, the network service provider 112 that provides network access in the particular geographical location, a Region Name dropdown menu 258, a Country dropdown menu 260, and a State dropdown menu 262. Further, the window 250 may also include an Access Type dropdown menu 264 that allows the user to select the type of access associated with the particular pricing map (e.g., modem, Wi-Fi, or the like). A media access type (e.g., a dialup access) may also be defined using a Media Access Type dropdown menu 266, and a site type (e.g., hotel, coffee shop, or the like) may be selected from a Site Type dropdown menu 268. Once the user has defined the appropriate criteria or parameters for the selected pricing map, the user may click the OK button 270 to process the modifications and/or selections or the Cancel button 272 to cancel any changes made. In a similar fashion, an Add button 229 (see FIG. 10), a Copy button 231, and a Remove button 233 may be activated to perform other related functionality associated with each pricing map.

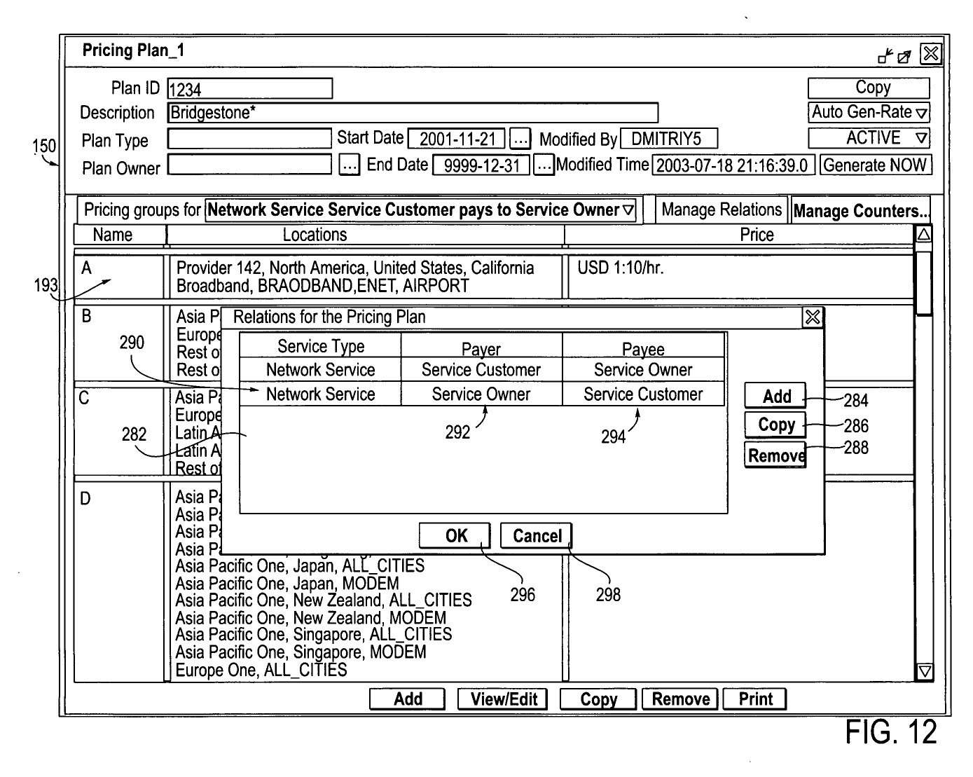

Each pricing plan that may be generated using the generic pricing plan main screen 150 (and optionally the pricing group details screen 200) may have one or more pricing relationships. For example, a pricing relationship may be a seller side relationship relating to remote network access sold by the network access broker and thus define what a customer pays the network access broker; a buyer side relationship where the network access broker buys network access from any one of the network service providers 112 and, accordingly, the network access broker pays the network service provider 112; or a clearing relationship where a customer may pay a network service provider 112 directly. In order to manage the plurality of pricing relationships, the generic pricing plan main screen 150 includes a manage relations button 280 (see FIG. 9) which, when activated by a user, generates a manage relations window 282 (see FIG. 12). The manage relations window 282 allows a user to add a payer/payee to a pricing plan using an Add button 284, copy an existing payer/payee relationship using a Copy button 286 and/or remove a payer/payee relationship via a Remove button 288. For each payer/payee relationship, a user may define a service type as shown at list box 290. A Payer list box 292 and Payee list box 294 may also be provided for the user to define a plurality of payees and payers. Once the appropriate data has been entered via the manage relations window 282, the user may then click an OK button 296 to process the payer/payee relationships entered or cancel any changes by activation of a Cancel button 298. In one embodiment, the service type list box 290 may be populated with data from tables in the data schema 180 (see FIG. 16). The relations for the pricing plan may be stored in a table of the data schema 180.

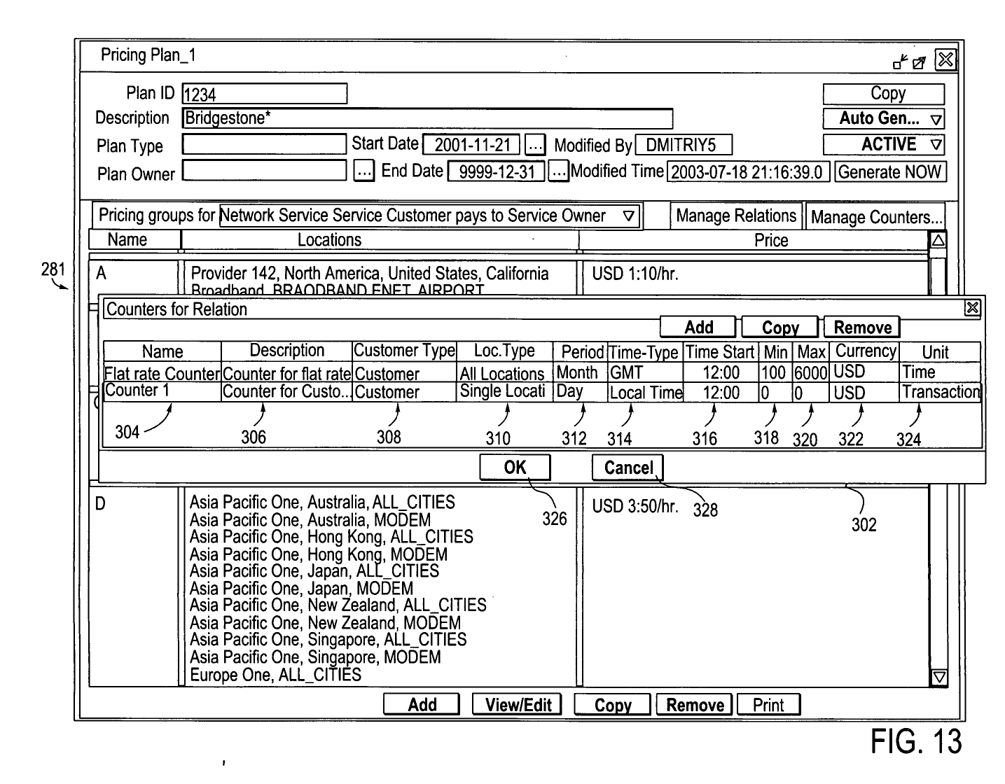

The manage relations window 282 may be associated with a selected pricing group (e.g., the pricing group 193) a user may activate a Manage Counters button 300 (see FIG. 9) in order to define or manage counters associated with pricing groups (e.g., the pricing group 193). Upon activation of the Manage Counters button 300, a manage counters window 302 (see FIG. 13) may be generated by the transaction management module 50. The manage counters window 302 may include a Name list box 304, a Description list box 306, a Customer Type list box 308, a Location Type list box 310, a Period list box 312, a Time Type list box 314, a Time Start list box 316, a Minimum list box 318, a Maximum list box 320, a Currency list box 322, and a Unit list box 324. Data to populate the various list boxes 304 to 324 may be stored in various tables. It will be appreciated that, in other embodiments of the invention, further list boxes may be included and some of the list boxes shown in FIG. 13 may be omitted. The manage counters window 302 may thus allow the network access broker to define counters which include data on various parameters relating to a particular pricing plan. In a similar fashion to that described above, the manage counters window 302 includes an OK button 326 to accept changes made via the manage counters window 302 or cancel any changes made by activation of a Cancel button 328.

Thus, the manage counters window 302 may allow a user to define various counters each of which have associated functionality. For example, as shown in the Name list box 304, a flat rate counter may be defined where a user is charged a flat rate for a given period (see the Period list box 312) and the user may access any location (see the Location Type list box 310) for a maximum duration during the particular period (see the Maximum list box 320). Likewise, further counters may be defined with other parameters such as, a counter for a specific day (see the Period list box 312) where a user may be charged per transaction (see the Unit list box 324). Thus, in one embodiment, the rate counters may define access relationships (e.g., payer/payee relationships) between parties of the multi-party service access environment 100.

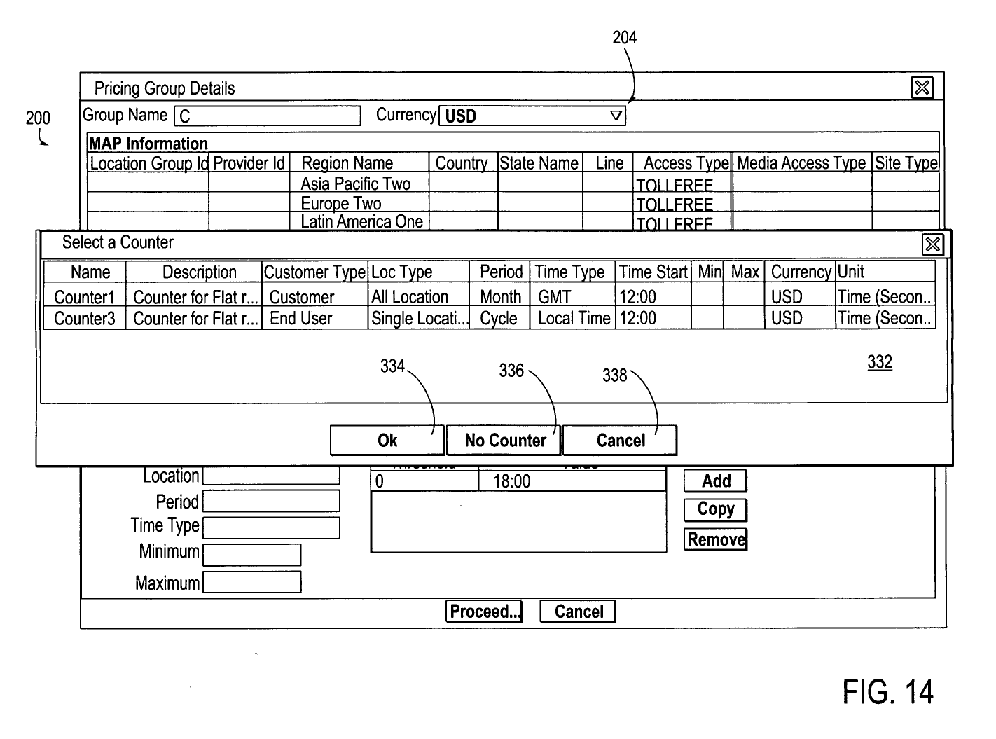

The rate counters that have been defined may then be selected or assigned to a particular relationship (e.g., a particular payer/payee relationship). For example, when a user selects the pricing group 193 (see FIG. 9) and, thereafter, activates the View/Edit button 192, the screen 200 may be presented to the user. Thereafter, upon activation of a counter button 330 (see FIG. 11) an assign counter window 332 (see FIG. 14) may be generated which displays the various counters for the various relations defined using the manage counters window 302 (see FIG. 13). The user may then select an appropriate counter and, thereafter, activate an OK button 334, select no counter by activating a No Counter button 336, or activate a Cancel button 338 to cancel the assign counter window 332.

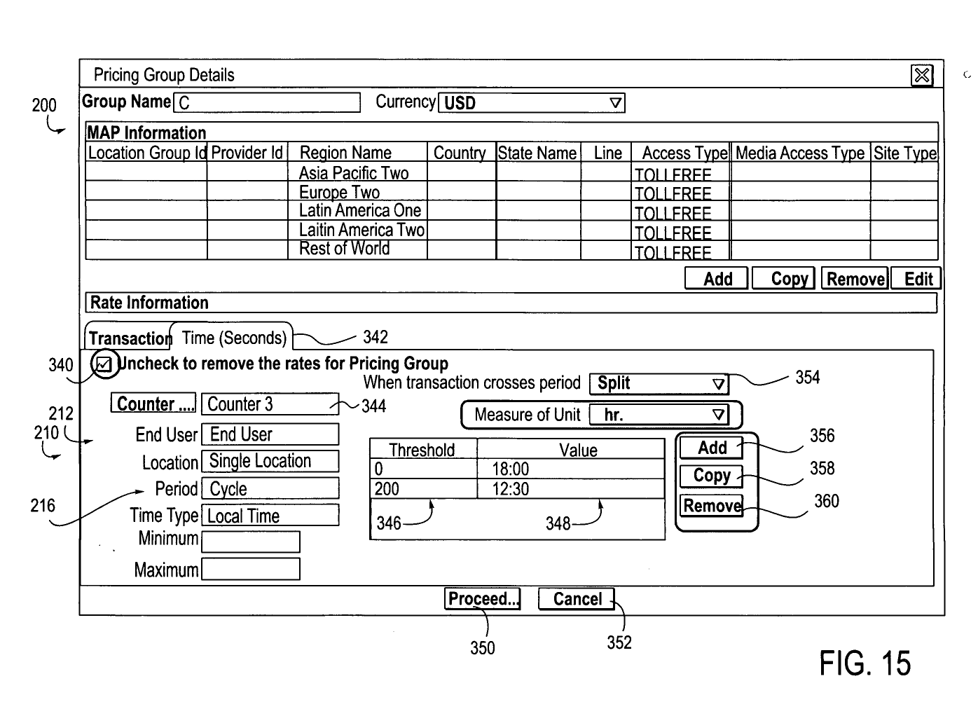

Once a counter has been assigned to a particular pricing group, rates for the particular group may then be provisioned. For example, a user may activate check box 340 (see FIG. 15) in order to enter rates (e.g., time based rates by selecting a Time tab 342). The displayed information associated with the Time tab 342 may show that the associated rate counter that has been selected is, for example, rate counter 3 (see counter field 344). Thereafter, a threshold may be entered in the Threshold list boxes 346 and a rate associated therewith may be entered by the user in a Value list box field 348. Once these values have been defined, the user may then activate a Proceed button 350 or cancel any entries via a Cancel button 352. In certain embodiments of the invention, activation of a Split button 354 provides split dropdown menu. In one embodiment, the two choices in the ‘split’ dropdown are “split” and “no-split”. If it is ‘split’, and if a transaction extends over two time intervals, it is split into two different transactions, one for each time interval (e.g. before midnight, and after midnight). If it is ‘no-split’, it's left as a single transaction. Further, Add, Copy and Remove buttons 356, 358 and 360 respectively may be provided to manage the provisioning of rates to a particular term. In order to remove the defined counter and rates from a particular pricing group, a user may uncheck the check box 340. Further, rates for each term may be stored in an appropriate table in the database (see FIG. 16).

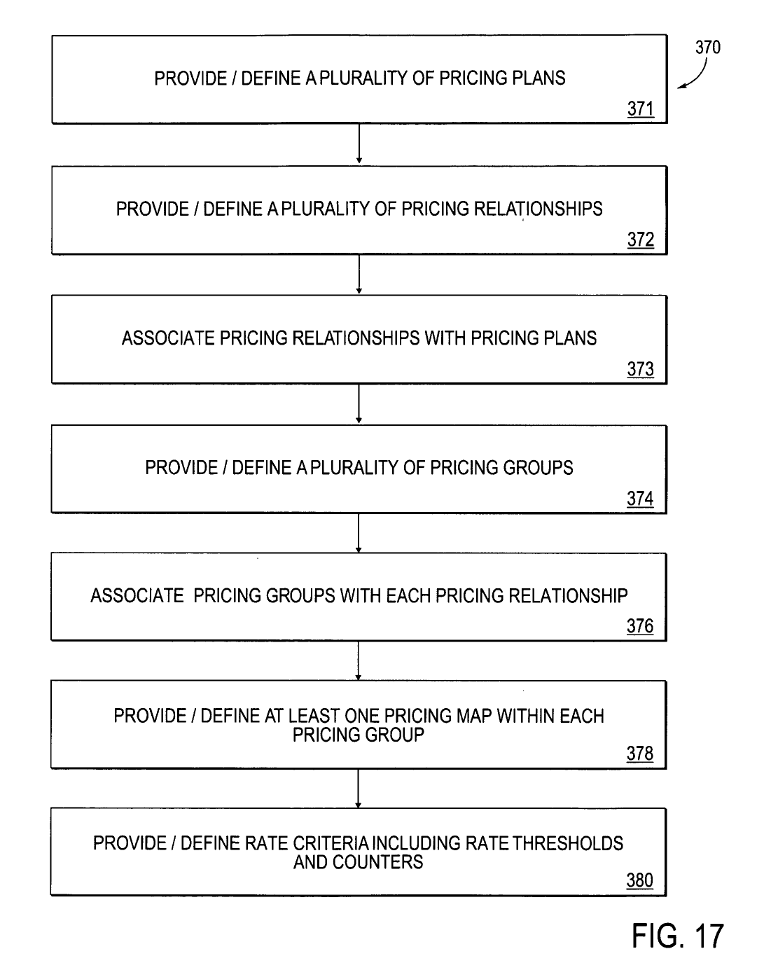

The functionality described above is broadly described in the method illustrated in FIG. 17. In particular, reference numeral 370 generally indicates a method, in accordance with the invention, to manage access transactions associated with a plurality of customers in a multi-party service access environment, for example, the environment 20 (see FIG. 1). The method 370 may define a plurality of pricing plans (see operation 371) and a plurality of pricing relationships (see operation 372) that are associated with the pricing plans (see operation 373). Further, the method 370 may define a plurality of pricing groups (see operation 374) associated with each pricing relationship (see operation 376). In one embodiment, one or more pricing maps may be defined within each pricing group (see operation 378). As shown in operation 380 and described above, rate criteria including rate thresholds and usage monitors or counters may be defined. In order to allow a user to customize the functionality of a transaction broker system (e.g., the transaction broker system 24 in FIG. 1), the method 370 generates a plurality graphic user interfaces (see for example FIGS. 9 to 15).

Exemplary Computer System

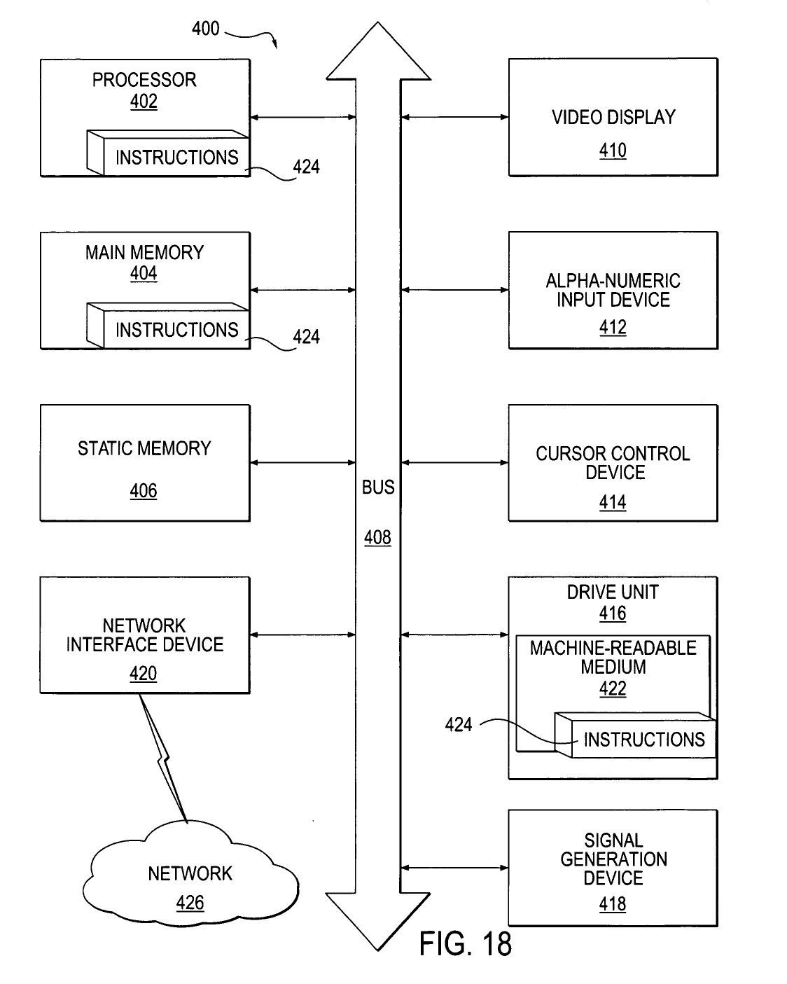

FIG. 18 shows a diagrammatic representation of machine in the exemplary form of the computer system 400 within which a set of instructions, for causing the machine to implement any one of the methodologies or modules discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 400 is shown to include a processor 402, a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g. a keyboard), a cursor control device 414 (e.g. a mouse), a disk drive unit 416, a signal generation device 418 (e.g. a speaker) and a network interface device 420.

The disk drive unit 416 may include a machine-readable medium 422 on which is stored a set of instructions (software) 424 embodying any one, or all, of the methodologies described above. The software 424 is also shown to reside, completely or at least partially, within the main memory 404 and/or within the processor 402. The software 424 may further be transmitted or received via the network interface device 420. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Thus, a method and system for managing transaction data in a multi-party service access environment are described. In the foregoing detailed description, the invention has been described with reference to specific exemplary embodiments thereof. It will, however, be evident that various modifications and changes may be made thereto without departing from the broader scope and spirit of the invention as set forth in the appended claims. The specification and drawings are, accordingly, to be regarded in an illustrative sense rather than a restrictive sense.

1. A method to manage access transactions associated with a plurality of parties in a multi-party service access environment, the method comprising:
providing a plurality of pricing plans, each party being associated with at least one of the plurality of pricing plans; and
providing a plurality of pricing relationships associated with each pricing plan, each pricing relationship defining a payer/payee relationship between at least two parties to the multi-party service access environment.

2. The method of claim 1, which comprises:
providing a plurality of pricing groups; and
associating each pricing group with a pricing plan.

3. The method of claim 1, which comprises generating a graphic user interface that allows functionality selected from the group including adding a pricing plan, editing a pricing plan, copying a pricing plan, and removing a pricing plan.

4. The method of claim 2, which comprises associating at least one pricing map with each pricing group, the at least one pricing group including a plurality of network access points that have substantially similar pricing characteristics.

5. The method of claim 4, which comprises generating a graphic user interface that allows a user to define the pricing characteristics associated with the pricing group.

6. The method of claim 4, wherein the at least one pricing map comprises a plurality of access points having common access criteria.

7. The method of claim 6, which comprises generating a graphic user interface that allows user selection of access criteria common to the pricing map, the common access criteria being selected from the group including a geographical region, a country, a state, a network access type, a media access type, and a site type.

8. The method of claim 1, wherein the relationships between the plurality of parties to the multi-party service access environment are payer/payee relationships.

9. The method of claim 8, which comprises generating a graphic user interface which allows a user to define a payer and a payee in each payer/payee relationship.

10. The method of claim 8, wherein multiple payer/payee relationships are associated with a single access transaction and the transaction is measured in one of units of time, a fee per transaction, units of data volume, and access speed.

11. The method of claim 10, in which a first payer/payee relationship regulates financial charges between the customer and an access broker, and a second payer/payee relationship regulates financial charges between the access broker and a network service provider.

12. The method of claim 10, which comprises defining rate criteria associated with each payer/payee relationship, the rate criteria including a financial charge which is based on at least one of a device type, a time unit, and a geographical location.

13. The method of claim 12, wherein each access transaction has at least two different associated rate criteria.

14. The method of claim 1, which comprises defining a rate associated with each access transaction and monitoring customer access and adjusting the rate when the customer access reaches a threshold value.

15. The method of claim 14, wherein the threshold value is at least one of a maximum pricing parameter and a minimum pricing parameter, the maximum pricing parameter defining a maximum charge for access during a given time period or a given data volume period, and the minimum pricing parameter defining a minimum charge for access during the given time period or the given data volume period.

16. The method of claim of claim 15, which comprises generating a graphic user interface which allows setting of the rate threshold.

17. The method of claim 1, which comprises providing the customer network access in the multi-party service access environment via a network broker that aggregates a plurality of network service providers, the network broker managing transactions between the network broker and the customer, and transactions between the network broker and the plurality of network service providers, the transactions arising from access by a party to a network of any one of the network service providers.

18. The method of claim 10, in which a first payer/payee relationship regulates financial charges between the customer and a network service provider, and a second payer/payee relationship regulates financial charges between the customer and the access broker.

19. The method of claim 10, in which a first payer/payee relationship regulates financial charges between the customer and a reseller, the second payer/payee relationship regulates financial charges between the reseller and the access broker, and a third payer/payee relationship regulates financial charges between the access broker and the network service provider.

20. A transaction management module to manage access transactions by a plurality of parties in a multi-party service access environment, the transaction module comprising:
a pricing plan module defining a plurality of pricing plans, each party being associated with at least one pricing plan; and
a plurality of payment relationship modules associated with each pricing plan and wherein each pricing relationship module defines pricing relationships between at least two parties to the multi-party service access environment.

21. The transaction management module of claim 20, which comprises a plurality of pricing group modules that are associated with a pricing plan.

22. The transaction management module of claim 21, in which each pricing group comprises at least one pricing map module that defines a pricing map including a plurality of network access points that have substantially similar pricing characteristics.

23. The transaction management module of claim 22, in which the at least one pricing map module comprises a plurality of access points having common access criteria.

24. The transaction management module of claim 23, wherein the common access criteria include one of a common media type, a common network service provider, a common geographic location, and a common media site type.

25. The transaction management module of claim 23, wherein the common media type comprises one of a dialup network, a Wi-Fi network, a cable network, and a DSL network.

26. The transaction management module of claim 24, wherein the common media site type relate to physical business locations performing substantially similar business functions.

27. The transaction management module of claim 21, which comprises a payer/payee module wherein the relationships between the plurality of parties to the multi-party service access environment are payer/payee relationships are defined.

28. The transaction management module of claim 27, wherein multiple payer/payee relationships are associated with a single access transaction and the transaction is measured in one of units of time, a fee per transaction, units of data volume, and access speed.

29. The transaction management module of claim 28, in which a first payer/payee relationship regulates financial charges between the access customer and an access broker, and a second payer/payee relationship regulates financial charges between the access broker and an network service provider.

30. The transaction management module of claim 27, wherein the payer/payee module defines multiple payer/payee relationships wherein a combination of the multiple payer/payee relationships relate to a single pricing plan.

31. The transaction management module of claim 21, which comprises a rates module to define a rate associated with each access transaction and wherein the rates module monitors access by a party and adjusts the rate when customer access reaches a threshold value.

32. The transaction management module of claim 31, which comprises a rate counter for monitoring when access by a party reaches the threshold value.

33. A machine-readable medium including instructions that, when executed by a machine, cause the machine to:
provide a plurality of pricing plans to a plurality of parties in a multi-party service access environment, each party being associated with at least one of the plurality of pricing plans; and
provide a plurality of pricing relationships associated with each pricing plan, each pricing relationship defining relationships between a plurality of parties to the multi-party service access environment.

34. The machine-readable medium of claim 33, which:
provides a plurality of pricing groups; and
associates each pricing group with a pricing plan.

35. The machine-readable medium of claim 34, wherein at least one pricing map is associated with each pricing group, the at least one pricing map including a plurality of network access points that have substantially similar pricing characteristics.

36. The machine-readable medium of claim 34, wherein the relationships between the plurality of parties to the multi-party service access environment are payer/payee relationships.

37. A transaction management module to manage access transactions by a plurality of parties in a multi-party service access environment, the transaction module comprising:
means to define a plurality of pricing plans, each party being associated with at least one of the plurality of pricing plans; and
means to define a plurality of pricing relationships associated with each pricing plan, each pricing relationship defining relationships between a plurality of parties to the multi-party service access environment.
